(19) United States
(12) Patent Application Publication
(10) Pub. No.: US 2003/0141876 A1
(43) Pub. Date: Jul. 31, 2003

(54) Circuit and method for measuring extinction ratio and controlling a laser diode transmitter based thereon

(75) Inventors: Daniel Mahgerefteh, Los Angeles, CA (US); Eva Peral, Pasadena, CA (US)

Correspondence Address: HITT GAINES P.C., P.O. BOX 832570, RICHARDSON, TX, 75083, US

(73) Assignee: Agere Systems Guardian Corp., Orlando, FL (US)

(21) Appl. No.: 10/060,004

(22) Filed: Jan. 29, 2002

(51) Int. Cl. H01H 31/02

(52) U.S. Cl. 324/537

(57) ABSTRACT

A circuit for, and method of, measuring an extinction ratio of a laser diode and a laser diode transmitter incorporating the circuit or the method. In one embodiment, the circuit includes: (1) an RF power detector, optically couplable to an output of the laser diode, for producing a varying voltage that is a function of an AC portion of modulated power generated by the laser diode and (2) an error signal generator, coupled to the power detector, for integrating the varying voltage over time to yield an integrated DC voltage that is a function of the extinction ratio.

### TECHNICAL FIELD OF THE INVENTION

The present invention is directed, in general, to laser diodes and, more specifically, to a circuit and method for measuring extinction ratio and controlling a laser diode transmitter based thereon.

### BACKGROUND OF THE INVENTION

An extinction ratio of a laser diode may be generally defined as the ratio of the average power when the laser diode is transmitting a logical “1” bit to that of the average power when the laser diode is transmitting a logical “0” bit. The extinction ratio of the output of a directly modulated laser diode transmitter may change with varying bias conditions, laser aging and temperature. A change in the extinction ratio can lead to errors in transmission.

There have been prior art attempts to measure or compensate for changes in the extinction ratio of laser diode transmitters. In one prior art attempt, a small modulating signal is superimposed on the top of a digital signal within the laser diode when the laser diode is ON. A slope efficiency of the laser diode is determined from this test, and from this characteristic is derived the extinction ratio. For more information, see D. W. Smith and T. Hodgkinson, “Laser level control for high bit rate optical fiber systems,” 13^{th} Circuits and Systems International Symposium, Houston, April 1980, pages 926-930, which is hereby incorporated by reference in its entirety. One problem with this prior art approach is that the low frequency ON state slope sensing scheme only works with lasers with good linearity with aging and over temperature.

A second prior art approach is to add a low frequency current dither to the electro-optical output signal in the OFF state of the laser. A bias is adjusted to maintain a certain above-threshold/below-threshold ratio, thereby adjusting the extinction ratio. For more information, see B. W. Hakki and F. Bosch, “Limitations of a Threshold Sensing Scheme for Lasers at High Bit Rates,” IEEE Photonics Technology Letters, Volume 1, No. 11, pages 291-292, which is hereby incorporated by reference in its entirety. One problem with this approach is that this threshold sensing scheme loses discrimination above 2 gigabits/second.

A third prior art approach is to use a direct amplitude detection in which a high speed detector is followed by an amplifier. The amplifier measures the output bits for feedback into a drive current. For more information, see R. E. Epworth, “Subsystems for High-speed Optical Links,” Second European Conference on Optical Communication, Paris, 1976, pages 377-382, which is hereby incorporated by reference in its entirety. One disadvantage of the direct amplitude detection scheme is that it is requires the use of a high speed photodiode and a transimpedance amplifier, which makes the device expensive. In addition, high speed and high gain amplifiers consume power and generate heat, raising the temperature of the laser package even further, and degrading the performance of the laser diode.

A fourth prior art approach utilizes a broadband approach in which a high-pass filtered output of a monitor photodiode is used to feedback the amplitude of the drive current. A detector followed by a low-pass filter gives an error signal for the amplitude. A second low-pass filtered output of photodiode feed back the DC bias of the laser diode. For more information, see Japanese Patent Application Number S56-200831 to Harushige Urata, which is hereby incorporated by reference in its entirety.

One drawback of the Harunshinge Urata scheme appears at high bit rates (10 gigabits/second) in which broad band radio frequency (“RF”) detection becomes difficult. RF detector designs can compromise sensitivity for speed. Hence, in a practical system a high speed amplifier is needed before detection as shown in the specific circuit FIG. 4 of Harushinge Urata. Since the photodiode is basically reactive, and its power transfer depends only on its capacitance, one is again forced to use a transimpedance amplifier with high gain to achieve high speed. Use of an operational amplifier shown in FIG. 6 of Harushinge Urata is also limited to low speeds (<1 gigahertz) because of its associated phase delay which causes instability in a feedback gain loop. Even with a transimpedance amplifier, a high-pass filtered signal does not provide an accurate measure of the extinction ratio. The output of the directly modulated laser diode of Harushinge Urata suffers severe ringing caused by relaxation oscillation. Hence the total modulated power in the signal measured by this scheme does not correspond to the standard definition of the extinction ratio.

Accordingly, what is needed in the art is a method of measuring and controlling an extinction ratio is a laser diode that overcomes the deficiencies of the prior art.

### SUMMARY OF THE INVENTION

To address the above-discussed deficiencies of the prior art, the present invention provides a circuit for, and method of, measuring an extinction ratio of a laser diode and a laser diode transmitter incorporating the circuit or the method. In one embodiment, the circuit includes: (1) an RF power detector, optically couplable to an output of the laser diode, for producing a varying voltage that is a function of an AC portion of modulated power generated by the laser diode and (2) an error signal generator, coupled to the power detector, for integrating the varying voltage over time to yield an integrated DC voltage that is a function of the extinction ratio.

The present invention therefore introduces the broad concept of monitoring and controlling an extinction ratio of a laser diode through monitoring low frequency characteristics of a bit stream of binary data. The varying voltage is preferably slowly varying.

In one embodiment of the present invention, the power detector includes: (1) a DC block and (2) an RF detector, coupled to an output of the DC block. Of course, those of skill in the art will understand that this is just one embodiment, and other embodiments may be appropriate.

In one embodiment of the present invention, the power detector further comprises a low pass filter interposing the DC block and the RF detector. Again, those skilled in the art will perceive that there are other embodiments of the power detector that would fall within the scope of the present invention.

In one embodiment of the present invention, the low-pass filter is a Bessel filter having a bandwidth of at least 1/10^{th} of a bit rate of the laser diode. Of course, those skilled in the art will perceive that there may be other values that may be used for the Bessel filter where appropriate, or that other filters may be used.

In one embodiment of the present invention, the laser diode is modulated with non-return-to-zero data. In another embodiment of the present invention, the laser diode is modulated with a pseudo-random bit sequence. In another embodiment of the present invention, the signal generator comprises a comparator. Of course, those skilled in the art will perceive that there are other embodiments of the data or signal generator that fall within the broad scope of the present invention.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates one embodiment of a circuit for measuring an extinction ratio of a laser diode built according to the principles of the present invention; and

FIG. 2 illustrates a method of measuring an extinction ratio of a laser diode.

### DETAILED DESCRIPTION

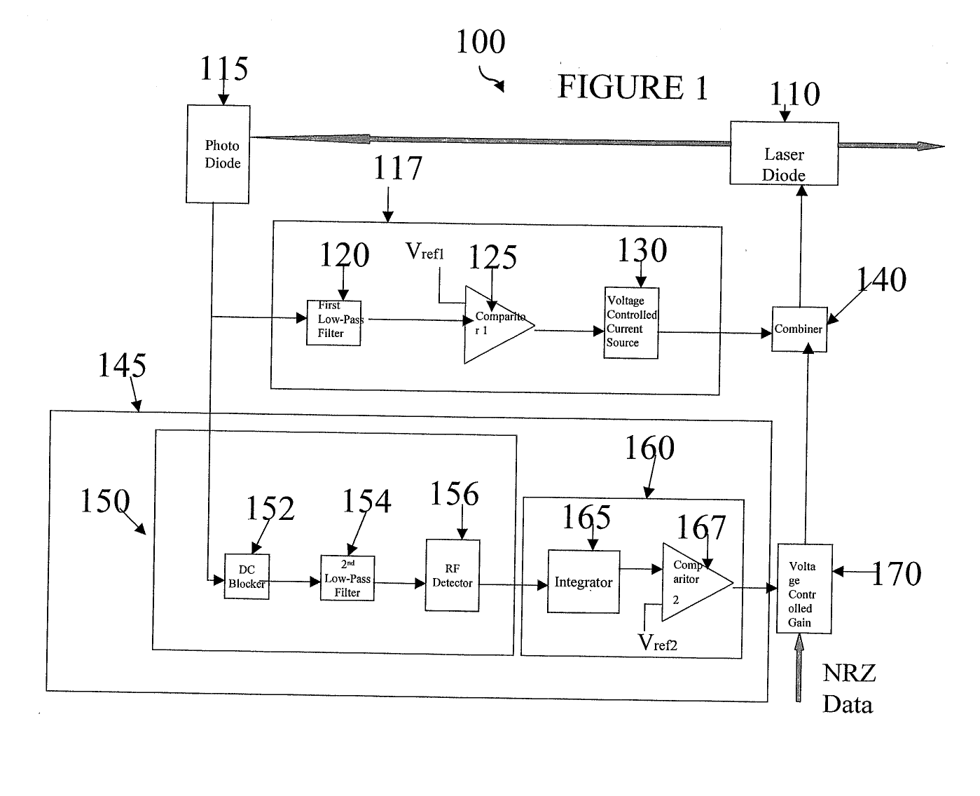

Referring initially to FIG. 1, illustrated is one embodiment of a circuit 100 for measuring an extinction ratio of a laser diode built according to the principles of the present invention. A digital signal extinction ratio (ER) may be defined as the average of the power in a “1” digital bit (P₁) to the average power of a “0” digital bit (P₀); ER=P₁/P₀. More precisely, an existing and publicly available Bellcore standard defines P₁ as the average powers measured in a 20% wide window in the middle of the 1 bit period, divided by a corresponding definition for P₀. In one embodiment of the present invention, the circuit 100 measures the low frequency portion of a spectrum of total modulated power, the modulated power corresponding to a power relationship between the “1” digital bits and the “0” digital bits. It has been determined that a low frequency portion of the modulated power can be calibrated to substantially correspond to the definition of the extinction ratio.

In one embodiment of the circuit 100, the circuit 100 has a laser diode 110, perhaps a high speed laser diode 110. The laser diode 110 is stimulated to emit coherent light out of both its “front” and “back” end. The laser diode 110 has information in the form of a string of bits, such as non-return-to-zero (NRZ) data, encoded or modulated upon its coherent light, to yield modulated optical power. The source of the information will be described in more detail, below. The “back” of the laser diode emits coherent light as well. This light impinges upon a photodiode 115 that is in optical communication with the laser diode 110. The photodiode 115 receives the modulated optical power and acts as a transducer of the modulated optical power by transforming it to an associated electrical signal, such as current or voltage.

The electrical characteristic of the photodiode 115 is passed through a DC loop 117. In the DC loop 117, the electrical output of the photodiode 115 is amplified by a low frequency amplifier (not shown) and passed through a first low-pass filter 120. (Amplification of the output of the photodiode 115 is not necessary, however.) The output of the first low-pass filter 120, which may be an integrator, is proportional to an average optical power out of the back of the laser. The average optical power out of the back of the laser is compared to a set reference voltage V_{ref1} corresponding to a desired average output power in a first comparator 125. A first error voltage signal from the first comparator 125 in provided to a voltage controlled current source 130. The output of the voltage controlled current source 130 is combined in a combiner 140 with the output of a voltage controlled gain amplifier 170, to be described later. In the controller 140, the DC bias of the laser is adjusted to keep the average optical power to a desired value, as defined by V_{ref1}.

The circuit 100 has an amplitude control loop 145, which has an RF power detector 150 and an error signal generator 160. The RF power detector 150 generally produces a slowly varying voltage that is a function of an AC portion of the modulated power generated by the laser diode 110. The error signal generator 160, coupled to the RF power detector 150, integrates the produced slowly varying voltage over time to yield an integrated DC voltage that is a function of the extinction ratio. The RF power detector 150 and the error signal generator 160 will be described in more detail below.

In the RF power detector 150, the output of the photodiode 115 is passed through a DC block 152, typically a capacitor, to remove the DC voltage portion of the output of the photodiode 115, leaving only the AC voltage portion. A second low pass filer 154 integrates the power of the received bit, i.e., the power received in the bit value of 1 or the bit value of 0. In one embodiment, a Bessel filter with a low frequency rolloff equal to 0.75 of the bit rate is used as the second low pass filter 154. According to one of the definitions of extinction ratio(see Fiber Optic Test and Measurement, Dennis Derickson, October 1997, Prentice Hall, which is hereby incorporated by reference in its entirety), filtering signals with a low-pass filter with 0.75 of the bit rate and the resulting signal characteristics can be used to determine the extinction ratio.

Specifically, an RF spectrum of a NRZ data random pattern is a sine² function with nodes, a first node at the bit rate. Most of the modulated power is contained in the low frequency portion of the spectrum up to approximately 0.75 of the bit rate. The higher frequencies, which are filtered out by the second low-pass filter 154, contain information about the particular pulse shape and transients and are not needed for control of the extinction ratio. In addition, the RF spectrum is nearly flat for a random sequence. Hence, using the second low pass filter 154 with a bandwidth of less than 0.75 of the modulated bit rate still gives an output which is nearly proportional to the total RF power. One key feature of the present embodiment is the use of the second low-pass filter 154, with a bandwidth 0.1B≦pass bandwidth of filter≦0.75 B.

After the AC signal has been filtered by the second low-pass filter 154, the AC signal is passed through a RF detector 156. The RF detector 156 may be a quadratic crystal, although other forms of rectifiers are well within the scope of the present invention. The RF detector 156 transmits the rectified signal out of the RF power detector 145 into the error signal generator 160.

The error signal generator 160 employs the output of the RF power detector 145 and feeds the voltage-controlled gain amplifier 170. An integrator 165 integrates the output of the RF detector 156. This is done for such reasons as to smooth out variations in the random or pseudo-random bit patterns. For a 10 gigabit system, a practical 1 second integration time for the integrator 165 averages over 10¹⁰ bits, which gives a fluctuation of approximately 10⁻³%.

After integrating by the integrator 165, an integrated voltage signal is passed to a second comparator 167, perhaps through its inverting input. The second comparator 167 compares the integrated voltage signal to a V_{ref2}. The value of V_{ref2} is set at a voltage level that corresponds to a desired extinction ratio, and the output of the second comparator is the second error voltage signal.

V_{ref2} is proportional to (10^{(ER/10)}−1)/(10^{(ER/10)}+1), where ER is the extinction ratio expressed in decibels and the proportionality constant depends upon the gain of the previous and following stages. If the voltage V_{ref2} is higher than the integrated voltage signal of the integrator 165, a positive rail voltage is provided to the voltage controlled gain amplifier 170 by the second comparator, and hence by the error signal generator 160, so the second error voltage signal is positive. If the voltage V_{ref2} is lower than the integrated voltage signal of the integrator 165, a negative rail voltage is provided to the voltage controlled gain amplifier 170 by the second comparator, and hence by the error signal generator 160, so the second error voltage signal is negative.

Upon receiving the second error voltage signal of the error signal generator 160, the voltage controlled gain amplifier 170 uses this signal to amplify modulated input data, perhaps a string of bits such as NRZ data, to an appropriate voltage. This string of bits may be a pseudo-random sequence. This amplified modulated data is employed within the combiner 140, ultimately for employment by the laser diode 110. Finally, the combiner 140 combines the output of the voltage controlled gain amplifier 170 and the DC loop 117, and determines what operating characteristics the laser diode 110 should have, and compensates therefore. To state the above with more specificity, the voltage controlled gain amplifier 170 employs input data, such as NRZ data, and determines the correct voltage signal that is ultimately interpreted by the laser diode 110 (after being combined in the combiner 140) to compensate for drifting in the extinction ratio.

In an alternative embodiment, the second low pass filter 154 of the RF power detector is removed. Instead, the photodiode 115 is chosen to have a moderate speed of between 0.1 and 0.75 of the bit rate of the laser diode 110. Use of this alternative embodiment precludes the use of a high speed voltage-controlled gain amplifier 170.

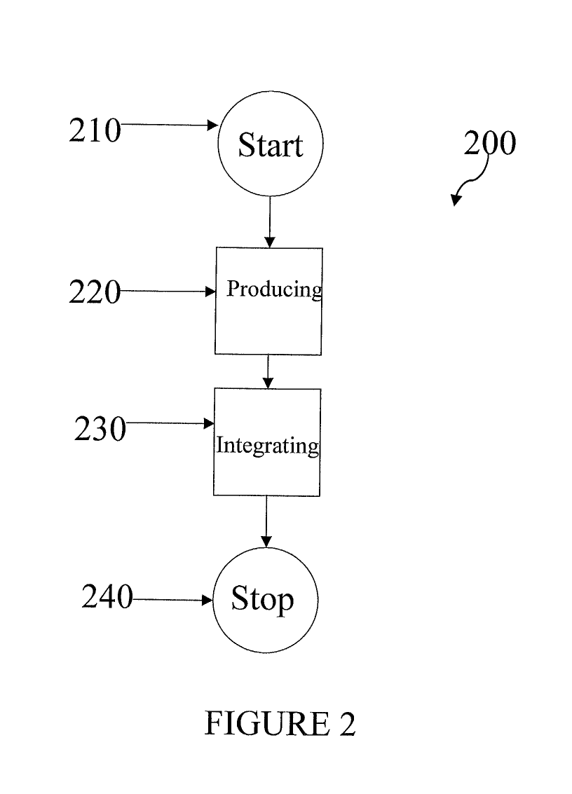

Turning now to FIG. 2, disclosed is a method of measuring an extinction ratio (method) 200 of a laser diode. After executing a start step 210, the method 200 executes a step of producing a slowly varying voltage that is a function of an AC portion of modulated power generated by the laser diode in a step 220. The step 220 may have the sub-steps of blocking a portion of the modulated power, perhaps the DC portion, and detecting an RF portion in the AC portion. The laser diode may be modulated with NRZ data with a pseudo-random bit sequence. The low-pass filtering of the step 220 may, in one embodiment, be carried out with a Bessel filter having a bandwidth of at least 1/10^{th} of a bit rate of the laser diode.

After finishing the step 220, the method 200 executes a step 230. The step 230 integrates over time the DC voltage produced in the step 220 to yield an integrated DC voltage that is a function of the extinction ratio. The integrated DC voltage is compared with a reference signal.

Although the present invention has been described in detail, those skilled in the art should understand that they can make various changes, substitutions and alterations herein without departing from the spirit and scope of the invention in its broadest form.

What is claimed is:

1. A circuit for measuring an extinction ratio of a laser diode, comprising:
an RF power detector, optically couplable to an output of said laser diode, for producing a varying voltage that is a function of an AC portion of modulated power generated by said laser diode; and
an error signal generator, coupled to said power detector, for integrating said varying voltage over time to yield an integrated DC voltage that is a function of said extinction ratio.

2. The circuit as recited in claim 1 wherein said power detector comprises:
a DC block; and
an RF detector, coupled to an output of said DC block.

3. The circuit as recited in claim 2 wherein said power detector further comprises a low pass filter interposing said DC block and said RF detector.

4. The circuit as recited in claim 3 wherein said low pass filter is a Bessel filter having a bandwidth of at least 1/10^{th} of a bit rate of said laser diode.

5. The circuit as recited in claim 1 wherein said laser diode is modulated with non-return-to-zero data.

6. The circuit as recited in claim 1 wherein said laser diode is modulated with a pseudo-random bit sequence.

7. The circuit as recited in claim 1 wherein said signal generator comprises a comparator.

8. A method of measuring an extinction ratio of a laser diode, comprising:
producing a varying voltage that is a function of an AC portion of modulated power generated by said laser diode; and
integrating said varying voltage over time to yield an integrated DC voltage that is a function of said extinction ratio.

9. The method as recited in claim 8 wherein said producing comprises:
blocking a DC portion of said modulated power; and
detecting a radio frequency portion in said AC portion.

10. The method as recited in claim 9 wherein said producing comprises further comprises low pass filtering said AC portion.

11. The method as recited in claim 10 wherein said low pass filtering is carried out with a Bessel filter having a bandwidth of at least 1/10^{th} of a bit rate of said laser diode.

12. The method as recited in claim 8 further comprising modulating said laser diode with non-return-to-zero data.

13. The method as recited in claim 8 further comprising modulating said laser diode with a pseudo-random bit sequence.

14. The method as recited in claim 8 further comprising comparing said integrated DC voltage with a reference signal.

15. A laser diode transmitter, comprising:
a laser diode that is modulated with a string of bits to yield modulated optical power;
a photodiode, in optical communication with said laser diode, that receives said modulated optical power;
an RF power detector, coupled to said photodiode, for producing a varying voltage that is a function of an AC portion of said modulated power; and
an error signal generator, coupled to said power detector, for integrating said varying voltage over time to yield an integrated DC voltage and generating an error signal that is a function of a comparison between said integrated DC voltage and a reference voltage, said integrated DC voltage being a function of said extinction ratio, said error signal employed to control a gain of said laser diode transmitter.

16. The laser diode transmitter as recited in claim 15 wherein said power detector comprises:
a DC block; and
an RF detector, coupled to an output of said DC block.

17. The laser diode transmitter as recited in claim 16 wherein said power detector further comprises a low pass filter interposing said DC block and said RF detector.

18. The laser diode transmitter as recited in claim 17 wherein said low pass filter is a Bessel filter having a bandwidth of at least 1/10^{th} of a bit rate of said laser diode.

19. The laser diode transmitter as recited in claim 16 wherein said string of bits is encoded in non-return-to-zero form.

20. The laser diode transmitter as recited in claim 16 wherein said string of bits is a pseudo-random sequence.
